(19) United States
(12) Patent Application Publication
(10) Pub. No.: US 2016/0092999 A1
(43) Pub. Date: Mar. 31, 2016

(54) METHODS AND SYSTEMS FOR INFORMATION EXCHANGE WITH A SOCIAL NETWORK

(71) Applicant: LinkedIn Corporation, Mountain View, CA (US)

(72) Inventor: Victor Louis Kabdebon, Sunnyvale, CA (US)

(21) Appl. No.: 14/533,355

(22) Filed: Nov. 5, 2014

Related U.S. Application Data
(60) Provisional application No. 62/057,868, filed on Sep. 30, 2014.

(51) Int. Cl. G06Q 50/00; H04L 29/06

(52) U.S. Cl. CPC G06Q 50/01; H04L 65/403

(57) ABSTRACT

Systems and methods are presented for providing information exchange between a social network and partners of the social network. In some example embodiments, a method is presented. The method may include accessing, at a device associated with a social network, information from a social network partner, with the information being offered as an exchange for information found in the social network. The method may also include determining a measurement of value to the social network of the information from the social network partner; accessing a confirmation to submit the information from the social network partner to the social network, based on the determined measurement of value; and exchanging the information from the social network partner for a measurement of credit based on the determined measurement of value and the submission confirmation.

### TECHNICAL FIELD

The subject matter disclosed herein generally relates to social networking. In some example embodiments, the present disclosure relates to systems and methods for providing information exchange with a social network.

### BRIEF DESCRIPTION OF THE DRAWINGS

Some embodiments are illustrated by way of example and not limitation in the figures of the accompanying drawings.

FIG. 1 is an example network diagram illustrating a network environment suitable for facilitating information exchange associated with a social network, according to some example embodiments.

FIG. 2 is a block diagram illustrating components of a social network system, according to some example embodiments.

FIG. 3 is an example illustration of an example set of information that may have value for a social network to have access to, according to aspects of the present disclosure.

FIG. 4 is an example set of information available in the social network that a social network partner may want access to, according to some example embodiments.

FIG. 5 is example member profile showing additional information that the social network partners may want access to and may want to exchange information for, according to some example embodiments.

FIG. 6 is an example interface for exchanging information with a social network, according to some example embodiments.

FIG. 7 is a flowchart illustrating example operations for providing information exchange with a social network, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems are presented for exchanging information associated with a social network. The abundance of information about individual members available in a social network can allow for the presentation of advertisements, offers, and suggestions for group affiliations to be more specific to the members, based on information they have presented about themselves. For example, in displaying information that a member is a fan of astronomy and stargazing, machines facilitating the social network can present to the member suggestions to join community groups centered around astronomy and stargazing, based on the machines having access to many other member profiles and the available community groups in the social network. As another example, in displaying the member's professional and educational background, companies, universities, and other partners of the social network may be able to present job postings personally to the member specific to his professional and educational background. In general, machines facilitating the social network can access a wealth of information about the individual members in order to present the individual members with advertisements and other networking opportunities that the individual members might not otherwise be exposed to outside of the social network. In this way, the publication and aggregation of information about individual members in the social network can have a synergistic effect, in that individual members can have access to opportunities they might not normally have access to by posting more information about themselves.

Similarly, it may be desirable for the social network to accept new information from its partners that would be of interest to the social network members. For example, by receiving a job posting from a company, university, or other social network partner, the social network members have an increased incentive to remain active in the social network, for the members know they can more easily access job posting information that may be relevant to them through the social network. In general, receiving new information from the social network partners can have value to the social network.

In some cases, social network partners also desire to access information available in the social network. For example, a company, university, or other social network partner may want to search a database of member profiles for possible candidates for a job posting. Through conventional means, the social network partner may pay a company running the social network to access one or more databases of member profiles. However, the social network partner may have valuable information to provide to the social network as well, as mentioned above. Thus, it may be desirable to provide a system and method for exchanging information between the social network and affiliates of the social network, such as the social network partners.

Aspects of the present disclosure are presented for providing methods and systems of exchanging information in a social network. In some example embodiments, information offered to be stored and displayed in the social network by affiliates of the social network may be processed and valued according to valuation algorithms. In some example embodiments, different types of information can be assessed and valued differently, depending on the value to the social network, including whether the social network already has access to that information. In some example embodiments, the information can be exchanged in a form of credits, whereby affiliates of the social network can thereafter exchange the credits for information found in the social network. In some example embodiments, the information found in the social network can also be weighted and/or valued differently, depending on how valuable the information is to the social network and or affiliates of the social network. This valuation may allow the social network partners to exchange their information for information found in the social network.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

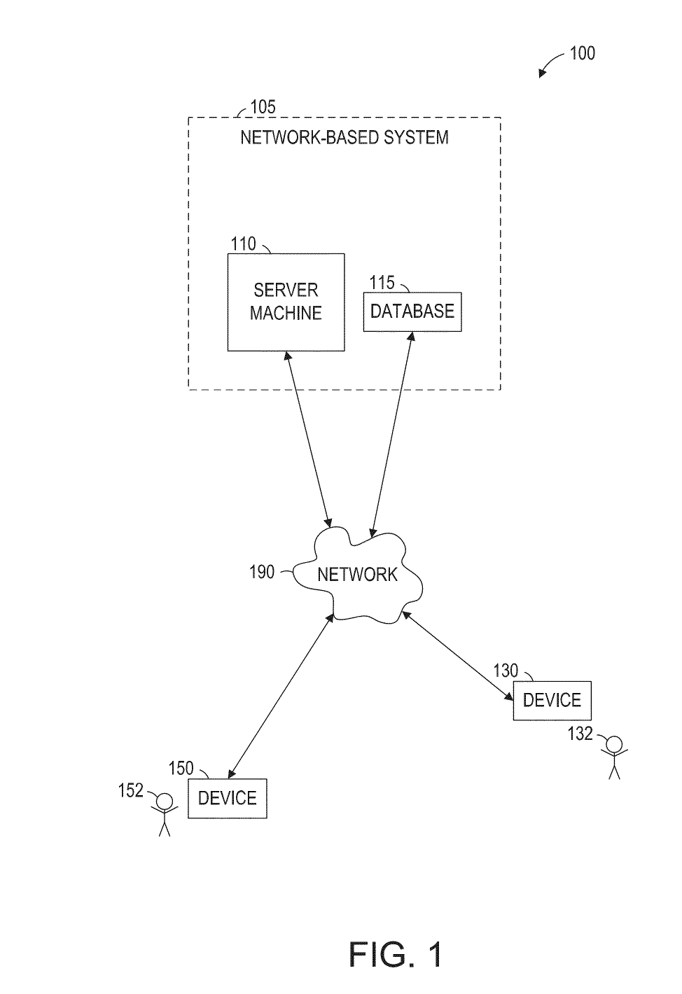

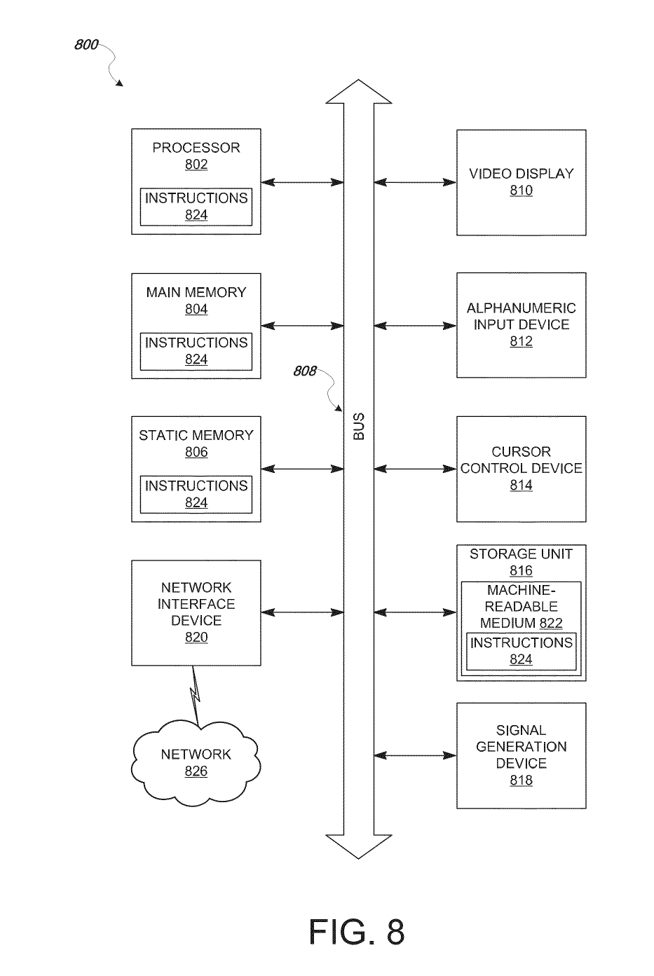

Referring to FIG. 1, an example network diagram illustrating a network environment 100 suitable for facilitating information exchange associated with a social network is shown, according to some example embodiments. The network environment 100 includes a server machine 110, a database 115, a first device 130 for a first user 132, and a second device 150 for a second user 152, all communicatively coupled to each other via a network 190. The server machine 110 may form all or part of a network-based system 105 (e.g., a cloud-based server system configured to provide one or more services to the devices 130 and 150). The database 115 can store search features (e.g., profile data, social graph data) for the social network service. The server machine 110, the first device 130, and the second device 150 may each be implemented in a computer system, in whole or in part, as described below with respect to FIG. 8.

Also shown in FIG. 1 are users 132 and 152. One or both of the users 132 and 152 may be a human user, a machine user (e.g., a computer configured by a software program to interact with the device 130), or any suitable combination thereof (e.g., a human assisted by a machine or a machine supervised by a human). The user 132 may be associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 may be associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 8. As used herein, a “database” may refer to a data storage resource and may store data structured as a text file, a table, a spreadsheet, a relational database (e.g., an object-relational database), a triple store, a hierarchical data store, or any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

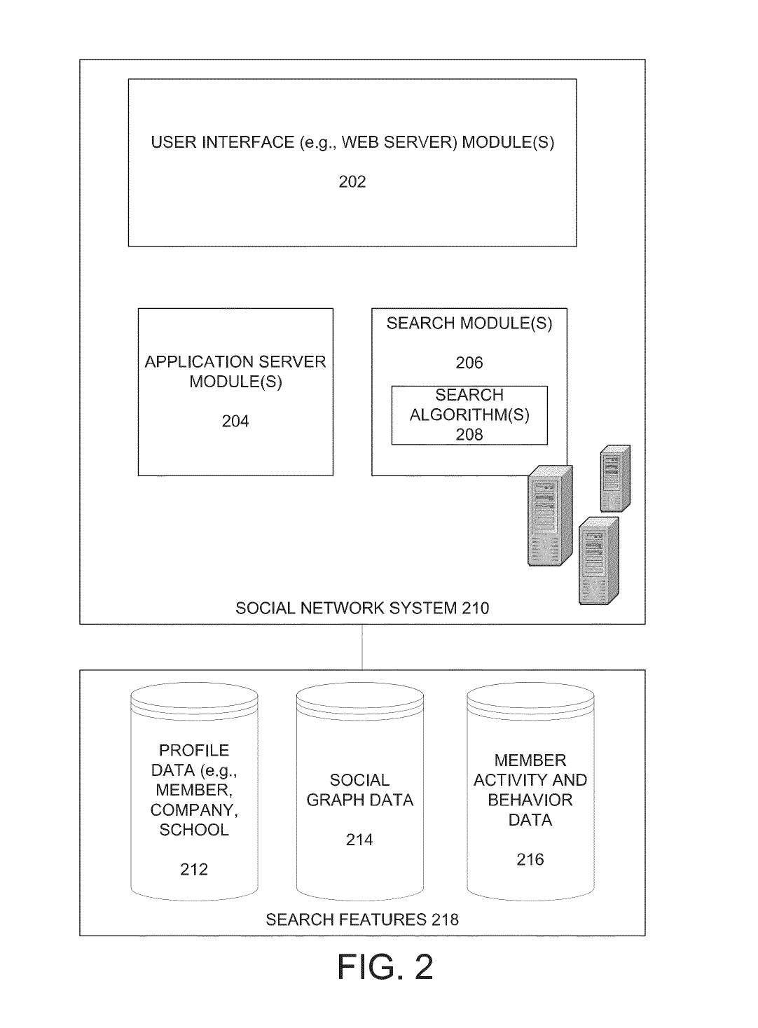

Referring to FIG. 2, a block diagram illustrating components of a social network system 210 is shown, according to some example embodiments. The social network system 210 may be an example of a network-based system 105 of FIG. 1 and may be suitable for facilitating information exchange associated with the social network system 210. The social network system 210 can include user interface module(s) 202, application server module(s) 204, and search module(s) 206, which may all be configured to communicate with each other (e.g., via a bus, shared memory, a switch). The search module(s) 206 can further include a database with search algorithms 208. Furthermore, the social network system 210 can communicate with database 115 of FIG. 1, such as a database storing search features 218. The search features 218 can include profile data 212, social graph data 214, and member activity and behavior data 216.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In FIG. 2, in some example embodiments, the front end can include a user interface module (e.g., a web server) 202, which can receive requests (e.g., search requests) via network 190 from various client-computing devices (e.g., devices 130 and 150), and can communicate appropriate responses to the requesting client devices. For example, the user interface module(s) 202 may receive search requests (e.g., name search requests) in the form of Hypertext Transport Protocol (HTTP) requests, or other web-based, application programming interface (API) requests. The application logic layer can include various application server module(s) 204, which, in conjunction with the user interface module(s) 202, can generate various user interfaces (e.g., web pages) with data retrieved (e.g., search results) from various data sources in the data layer. With some embodiments, individual application server modules 204 are used to implement the functionality associated with various services and features of the social network system 210.

The search module(s) 206, in conjunction with the user interface module(s) 202 and the application server module(s) 204, can present search results based on search algorithm(s) 208. The search algorithm(s) 208 can perform functions for recommending volunteer opportunities to users of the social network system 210, according to some example embodiments. The search algorithm(s) 208 can utilize the various data included in the search features 218, including profile data 212, social graph data 214, and member activity and behavior data 216. Search algorithm(s) 208 can include machine learning techniques. For example, a searcher can request a name search. The search module(s) 206 can use the search algorithm(s) 208 to present names of users in the social network system 210 that may be relevant to the searcher based on search features 218 that are specific to the searcher.

Still referring to FIG. 2, the data layer can include several databases, such as a database for search features 218 for storing profile data 212, including both member profile data as well as profile data for various organizations. Additionally, the database for search features 218 can store social graph data 214 and member activity and behavior data 216.

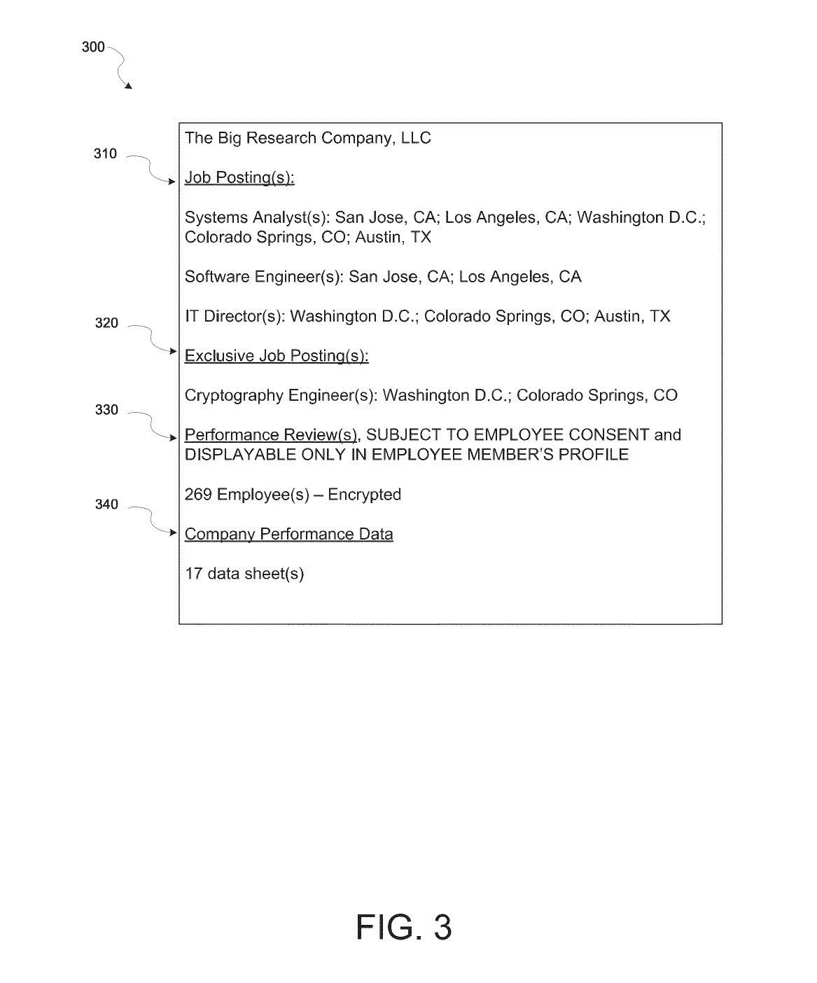

Referring to FIG. 3, example illustration 300 shows an example set of information that may have value for a social network to have access to. The example set of information may be provided by a partner of the social network, such as “The Big Research Company, LLC.” An analyst of The Big Research Company may be an example of user 132 or 152. Alternatively, a computer or an analyst operating a computer of The Big Research Company may be another example of user 132 or 152. In some cases, a computer of The Big Research Company configured to store the information shown in illustration 300 and to interact with the social network system 210 may be an example of the device 130 or 150. As used herein, a “partner of the social network” or a “social network partner” may refer to any organization that conducts business involving the social network with the company running the social network. For example, social network partners can include any companies that are licensed to run advertisements in the social network, or any recruiting companies that may search social network databases for members whose profiles may match qualifications for job postings.

Example illustration 300 shows various types of information that may have value to the social network, including having value to members in the social network. For example, various job postings 310 are displayed, showing a number of types of jobs available in The Big Research Company and where these jobs are generally located. These job postings 310 may be valuable to certain members in the social network who may be looking for jobs and who have the qualifications to apply for these job postings. The members in the social network may value having this information available in the social network, in that the members may not need to search as hard to find these job postings. In other words, the social network may be able to provide multiple job postings for their members in a single place in the social network, rather than having the member search different message boards and other websites in the Internet and other tangible mediums for the same job postings. In this way, the job postings 310 can be valuable to the social network, as they are valuable to the members of the social network.

As another example, other valuable pieces of information can include exclusive job postings 320. That is, the job postings may be provided only to members in the social network. The exclusive job postings 320 may be even more valuable to the social network than the regular job postings 310 because members in the social network would be competing for these jobs only amongst themselves, rather than in addition to the outside community. Thus, by offering these exclusive job postings 320, the social network may have even more value to the social network.

As another example, a company, such as The Big Research Company, may also provide exclusive data about its employees that the employees may be then authorized to post on their member profiles. An example of such information could include data from performance reviews 330. Information from the performance reviews 330 can include a variety of performance metrics, such as scores about an employee's work qualities and professionalism. The performance reviews 330 can also include comments from managers and other colleagues. The performance reviews 330 can also include descriptions of any raises and promotions. In conventional systems, while a member can disclose the ratings and other information in his performance review on his own, it is also possible for a member to provide fake ratings or other information in an effort to artificially boost his profile. Here, however, the performance reviews 330 can be certified by the employer, such that the information for the performance reviews 330 can be published in a member's profile with an official certification from one or both of the social network and the employer, stating that the performance reviews are legitimate. In some cases, the data for the performance reviews 330 can be displayable only in the member profile belonging to the employee of that performance review, and the member will be given the option of what information to display from the performance review. Based on these characteristics, the information in the performance reviews 330 could be very valuable to the members in the social network, and further, because of its exclusivity, the performance reviews 330 may be very valuable to the social network.

As yet another example, a company, such as The Big Research Company, may provide additional information, such as performance data about the company 340. The company performance data 340 may include a variety of metrics describing the performance of the company, from detail as broad as company profits and descriptions of the company business, to as specific as revenue breakdowns in individual sectors of divisions within the company, specific types and numbers of jobs hired, specific types and numbers of layoffs, salary ranges of specific jobs, descriptions of benefits, and any other kind of metrics or statistics that may be used to describe a company. In some cases, some of this information may be available publicly, either on the company website or through obligatory public disclosures, such as the types of information provided by a corporation according to Securities and Exchange Commission (SEC) regulations. If the social network already has found at least some of the data in the company performance data 340, that data may not be as valuable to the social network. However, there may be other cases where at least some of this data may be hard to find publicly or may simply be exclusive data known only to the company. In these cases, this data may be quite valuable to the social network. In either case, information about a company may be valuable to members of the social network in that the social network can provide a convenient location for members to learn about specific details of a number of different companies. Thus, the company performance data 340 may have value to the social network.

While illustration 300 shows a number of examples of types of data that the social network partner may be able to provide, other types of data known to persons of skill in the art may also be pertinent to the social network, and embodiments are not so limited.

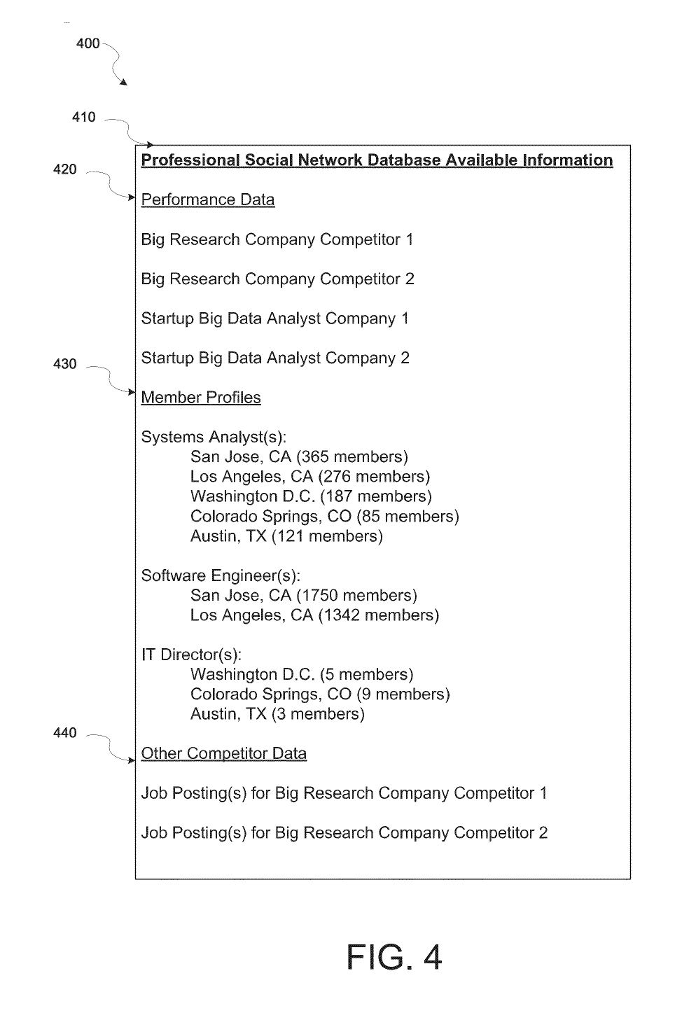

Referring to FIG. 4, illustration 400 shows an example set of information available in the social network that a social network partner, such as The Big Research Company, may want access to. As shown, the information may be available in a database 410, which may be consistent with the database 115. Database 410 may reside in the network-based system 105, for example. The listings in the database 410 show titles or broad descriptions of sets of information of each of the broad descriptions, either through links from the broad descriptions, through other pages of the database, other cells of the database, and so forth. In addition, The Big Research Company may also want to access performance data about smaller companies that could be partnered with or acquired by The Big Research Company, such as Startup Big Data Analyst Company 1 or Startup Big Data Analyst Company 2.

For example, the social network may have accumulated performance data 420 of other companies that may or may not be partners of the social network. A social network partner, such as The Big Research Company, may have an interest in acquiring performance data about specific companies, such as competitors of The Big Research Company. The performance data 420 of other companies may be similar to the performance data 340 about The Big Research Company, except of course the performance data is about the other companies.

As another example, the social network may also be able to provide broad statistics about its members, as shown in the member profiles category 430. Here, the social network may be able to provide information on how many of its members describe themselves as a certain type of professional, such as systems analyst, software engineer, information technology (IT) director, and so forth. In addition, the social network may also be able to provide the number of members of each type of profession or the number located in areas relevant to the social network partner. While the social network partner may be able to find at least some of this data by publicly mining through the social network, in may be much more convenient for the social network partner to obtain this data from the social network itself.

As yet another example, the social network may also be able to provide data from other competitors, such as job postings from competitors of the social network partner, as shown in the other competitor data category 440. The descriptions of the job postings in competitor data 440 may be similar to what the social network partner may provide for job postings (see, e.g., job postings 310), except of course it is pertinent to the social network partner's competitors. A social network partner may desire to access this kind of information to know what its competitors are doing, and so it can get a broad understanding of the market, as well as a sense of what kind of leverage it has when considering potential candidates.

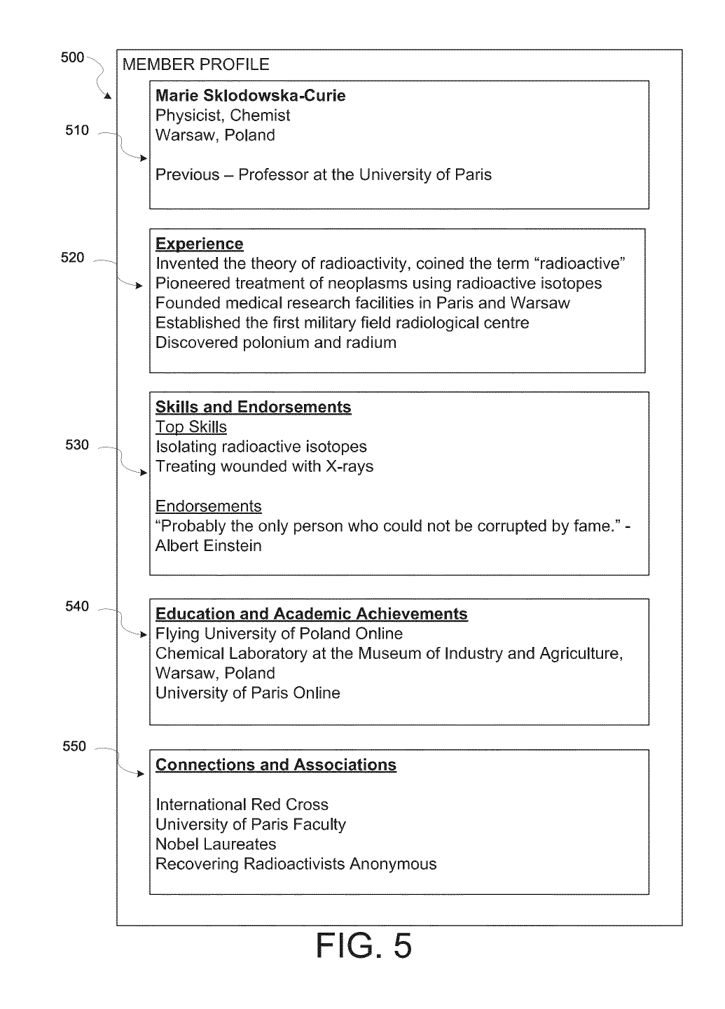

Referring to FIG. 5, example member profile 500 shows additional information that the social network partners may want access to and may want to exchange information for, according to some example embodiments. The member profile 500 can include information from the profile data 212, social graph data 214, and/or member activity and behavior data 216. The member profile 500 may be stored in memory in a networked server, such as database 115 residing in the network-based system 105.

The social network partners may want to reach out to or contact members in the social network based on information provided by the members in their member profile 500. For example, if the social network partner is trying to find suitable candidates for a job position, the social network partner may want to access certain member profiles that exhibit qualifications that may meet the job description. Various information can be available in the member profile 500 that the network partner may want to access to in order to determine whether to contact the member of member profile 500. For example, introductory information in window 510 can supply a member's name, geographic location, current occupation, and previous experience. In addition, information in the experience window 520 can provide more detail regarding the member's current and previous work experience, including a more complete history, description, and dates of service.

As another example, window 530 can include a description of skills and endorsements that the member possesses. In this example, a listing of “top skills” is shown, but other information can be included, including a listing of generic skills, any certifications to demonstrate skill or expertise in a particular field, names of other users who have endorsed the member for a particular skill, and a listing of categories for which the member has been endorsed.

As yet another example, window 540 can include a listing of the member's education. Names of schools and universities, types of degrees, areas of study within those degrees, test scores, and educational certifications can be listed. The member may also include a description or listing of classes taken, and any grades or honors worth noting.

As yet another example, window 550 can include a listing or description of connections of people and organizations with which the member is associated. Additional descriptions, such as listings of particular individuals, names of associations, religious organizations, and club memberships can be included in window 550.

In some example embodiments, any or all of this information in example member profile 500 may be helpful for a social network partner to access in order to determine whether the member should be contacted. For example, a social network partner may want to find all members who list having a top skill related to “radioactivity” (as listed in window 530), and who are located in particular geographic areas, based on their listed location in window 510. Similarly, a social network partner may want to access members based on a particular educational background (see window 540) or particular key terms listed in their experience (see window 520). In general, while illustrations 400 and 500 show a number of examples of types of data that the social network partner may want to access available in the social network, other types of data known to persons of skill in the art may also be pertinent, and embodiments are not so limited.

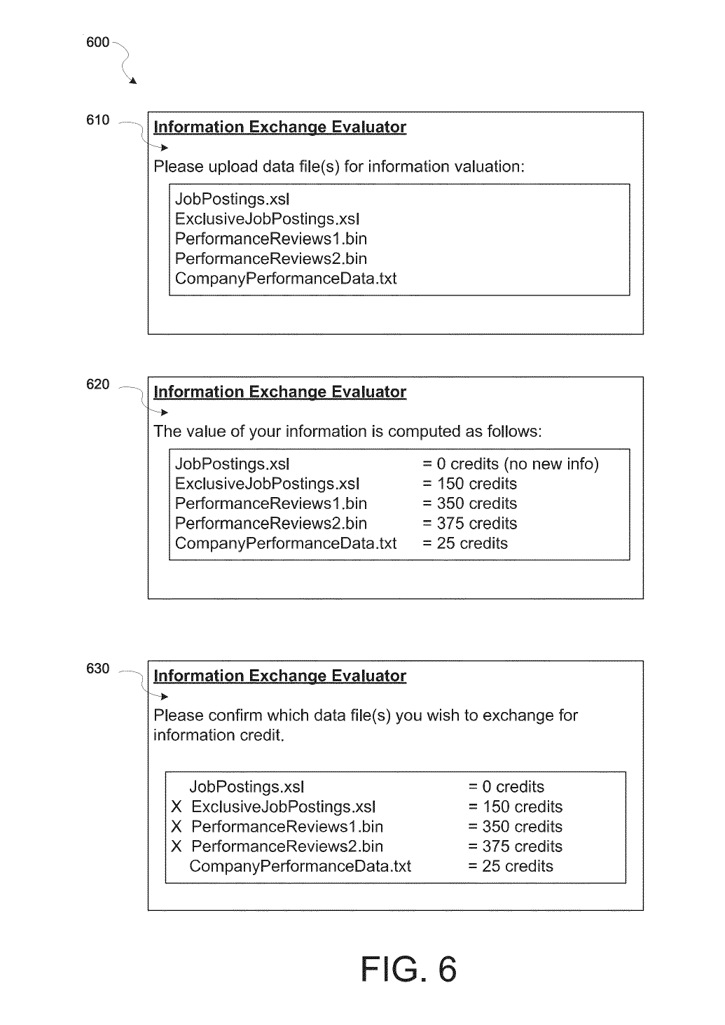

Referring to FIG. 6, illustration 600 shows an example interface for exchanging information with a social network, according to some example embodiments. Illustration 600 shows an example series of screenshots that a user 132 or 152 from a social network partner may interact with. The example screenshots in illustration 600 may be provided by the user interface module 202, for example.

Window 610 shows an example display of a first interface window for exchanging information with a social network, according to some example embodiments. In this example, the user 132 may be prompted to upload one or more data files containing information that may be of value to the social network. Examples of this type of information may be consistent with the descriptions in FIG. 3, for example. Here, the user 132 may have selected a number of different data files with different file types, as shown in example interface 610. The data may be arranged in a number of different formats, although in other cases the format of the data may be specified by the social network, according to some example embodiments.

After confirming which data files are intended to be offered to the social network, the user interface module 202 may provide an indication of how much or how valuable each of the data files is worth, as shown in example window 620. Here, each of the data files is described as having informational worth in units of “credits.” In some example embodiments, some virtual exchange like credits may be used to quantify the relative value of each of the pieces of information provided by the social network partner. Here, for example, the information in the performance reviews, as evidenced by the “PerformanceReviews1.bin” and “PerformanceReviews2.bin” files, has been evaluated as having the most value relative to the other files. Qualitatively, this may be because the information in the performance reviews is information exclusive to the social network partner, and/or may contain information that has high value to the social network and/or its members. As another example, some information may have relatively low value to the social network (an example of which is the “CompanyPerformanceData.txt” file). This information may have low value because the information may be readily available elsewhere on the Internet, and/or the information may not be very useful to the social network or its members. As shown in example window 620, sometimes some information offered by the social network partner may not have any value, and may therefore be evaluated as having zero credits, as an example. As an example, information that the social network already knows may have zero value to the social network when offered by the social network partner. As another example, inappropriate or illegal information may also have zero value to the social network. An example method for determining the value of information being offered to the social network is described below.

In some example embodiments, providing information to the social network may be performed in at least two stages: determining the value of the information and then determining which pieces of information to offer to the social network based on the determined value. Thus, in some cases, an additional interface may allow a user of the social network partner to select which pieces of information to submit to the social network after having determined the value of each piece of information, as shown in window 630, for example. Here, for example, the information about the job postings may be moot to offer because that information has been determined to have zero value to the social network. As another example, the company performance data may not be selected either, because it may be determined that it is not worth divulging that information while gaining so little value in return. This determination can be made by a user interfacing with the social network. In some example embodiments, this determination may be made by a computer according to an algorithm associated with the social network partner. For example, the social network partner can make its own determination of the value of keeping its information private, and provide the information to the social network if the value to the social network is greater than the determined value for keeping the information private.

In some example embodiments, because the information offered by the social network partner may first need to be evaluated for determining whether to actually submit the information, a sort of escrow service for holding the information before finally submitting may be provided by the social network or other system according to embodiments of the present disclosure. As an example, an independent system may interface with the social network partner and determine the value of the information before transmitting the information over to the social network.

The following is an example algorithm that a computer of the social network may perform to determine the value of information offered by social network partners. For example, the server machine 110 may perform the following process after receiving one or more data files of information through the network 190 from a device 130 of the social network partner.

Deconstructing the Information.

A data file “B” of information can be “sliced” or deconstructed into several pieces of information. The deconstruction may be based on one or more factors or criteria. For example, each piece of information can be related to one business entity in the social network. As another example, each piece of information may be subdivided based on the location in the data file, such as one piece of information for each cell or each row in a spreadsheet of the data file. In other cases, the algorithm may search for headings or subheadings to determine categories of information and subdivide the data file into these categories or subcategories.

Each of these sub-pieces of information can be designated as b(1), b(2), b(3), and so forth. In some cases, any information that cannot identified during deconstruction, e.g., the information that cannot be tied to a business entity, will be discarded and designated as b′.

Therefore, the data file B can be viewed as:

B=sum[b(n)]+b′

Evaluating the Information's “Worth.”

The “worth” (w) of each piece of information b(n) may be defined as “how valuable this information is to the social network.” The worth of each piece of information may be determined irrespective of whether the social network is initially in possession of the information.

In some cases, worth can be given a numerical value, such as a number that ranges from [0,W_max]. As an example, W_max may be equal to 2 and thus the worth w(n) of each b(n) has a numerical value between 0 and 2. In some cases, these values w(n) might fluctuate and are dependent on the business needs of the social network. In other cases, w(n) for each b(n) may have a numerical range much larger, such was W_max being equal to 100 or 1000.

Mechanism to Evaluate the w Factor.

In some example embodiments, there may be several factors for evaluating the worth w(n) of each piece of information b(n). For example, w(n) may be based at least in part by the trustworthiness of the social network partner offering b(n). In some cases, a reputation score can be given to each social network partner who offers to share information with the social network. This reputation score may be based on a number of factors determined previously, such as how long-standing the relationship is with the social network, an overall reputation based on visibility in the social network and within the community at large, the size or age of the company, or other factors apparent to those with skill in the art. As another example, w(n) may be based on the type of information being presented. w(n) may be about a job description, or about characteristics of one or more members in the social network. In some cases, pre-existing scores based on the type of information may be applied to each b(n). As another example, w(n) may increase based on an estimate of how unique the piece of information b(n) is, meaning how likely it is that the information is not known through other sources. In some cases, these factors modify w(n) in an additive manner, e.g., worth of content+uniqueness+reputation of source. In other cases, these factors modify w(n) in a multiplicative manner, e.g., worth of content*uniqueness factor*reputation factor.

Determining Initial Base Worth of the Information.

In some example embodiments, the type of information presented in each b(n) (e.g., job posting, performance review of a member, information about a company, etc.), referred to herein as the initial base worth of the information b(n), may be based on a number of factors. For example, the initial base worth can be derived from the business need of the social network at the time the information is exchanged (dynamic pricing), or it can fixed. In some cases, the business needs corresponding to initial base worth for each b(n) can be expressed in a table, an example of which is shown. As another example, the initial base worth can be based on the demand for such information, based on, for example, a number of views received for each type of information.

TABLE 1

| category of piece of information | Value (example) |
|---|---|
| Job posting for small company | 50 |
| Job posting for big company | 10 |
| Information on company | 5 |
| Exclusive job posting | 55 |
| Miscellaneous | 3 |

Valuation of b(n) to the Social Network.

Given the worth of each piece of information b(n), independent and irrespective of whether that information is already known to the social network, the value of b(n) to the social network can then be based on the worth w(b(n)) of each piece of information, offset or scaled by a factor “k” based on what degree the social network is in possession of the information. For example, if all information of b(n) is already known to the social network, then k(n)=0. This can be verified by checking if for each b(n) the same information is in a database of the social network, e.g. the database 115, as an example. If only a portion of the information b(n) is in the database 115, then k(n) would be a non-zero value between 0 and 1. The value of k(n) may be based on a proportion of how much of the information b(n) is already known to the social network. In some example embodiments, k(n) may also be based on a determination of how different the b(n) is from the information in the social network. For example, b(n) may contain the same informational content as what is in the database 115, but the information in b(n) may be worded differently or organized differently. k(n) therefore may have a non-zero value as a result.

The final value function of the information can therefore be expressed as:

value(B)=value(b1)+value(b2)+value(b3)+ . . . +value(b′)

Since value(b′)=0 by definition this leads to:

value(B)=value(b1)+value(b2)+value(b4)+ . . . +value(bn)

value(B)=w(b1)*k(b1)+w(b2)*k(b2)+w(b3)*k(b3)+ . . . w(bn)*k(bn)

Example Process for Computing Value to the Social Network.

Based on the above analysis, the following example steps can be used to determine the overall value of a set of information B to the social network. Example evaluation steps can include:
a. Text analysis and information extraction
b. Deconstruction of the information into pieces b(n)
c. Determine worth of each b(n)
   i. Determining relevancy of each piece of information b(n) for the social network
   ii. Determining initial base value of each piece of information b(n)
   iii. Determining uniqueness of the information b(n)
d. Comparison between what the information is in the database 115 and the what the information is in the offered information b(n) to obtain scalar k(n)
e. Scaling worth of each b(n) by k(n)
f. Determining overall value by summing each value w(n)*k(n)

Querying Data from the Social Network.

As mentioned above, a similar calculation can be used to determine value for information to be accessed in the social network by social network partners. This information can be called “Q”—the set of data that is being asked. Similarly, Q can be decomposed into sub queries that query specific entities in the social network. Thus:

Q=q1+q2+ . . . +q′

In the case of Q, “worth” can be defined as “how unique to the social network this data is.” For example, the “skills and endorsements” category in a member profile, such as in window 530, may have a high worth value because this information may not be readily available through other websites found online.

Worth for Q can also be dynamically adjusted. For example, the worth of q(n) may increase for a particular social network partner if that social network partner is accessing q(n) very frequently.

Valuation of Q.

The same logic previously used can be established:

value(Q)=value(q1)+value(q2)+ . . . +value(q′)

value(Q)=value(q1)+value(q2)+value(qn)

value(Q)=w(q1)*k(q1)+ . . . +w(qn)*k(qn)

Storing Data and Reward System.

In some example embodiments, the information from the social network partner in the information to be delivered to the social network can be stored using a unique key given to each social network partner. In some example embodiments, credits accumulated by the partners could be used in multiple ways (for example, exchanged for recruiting services of targeted members in the social network offered by the social network, for preferential access to some information, and the like).

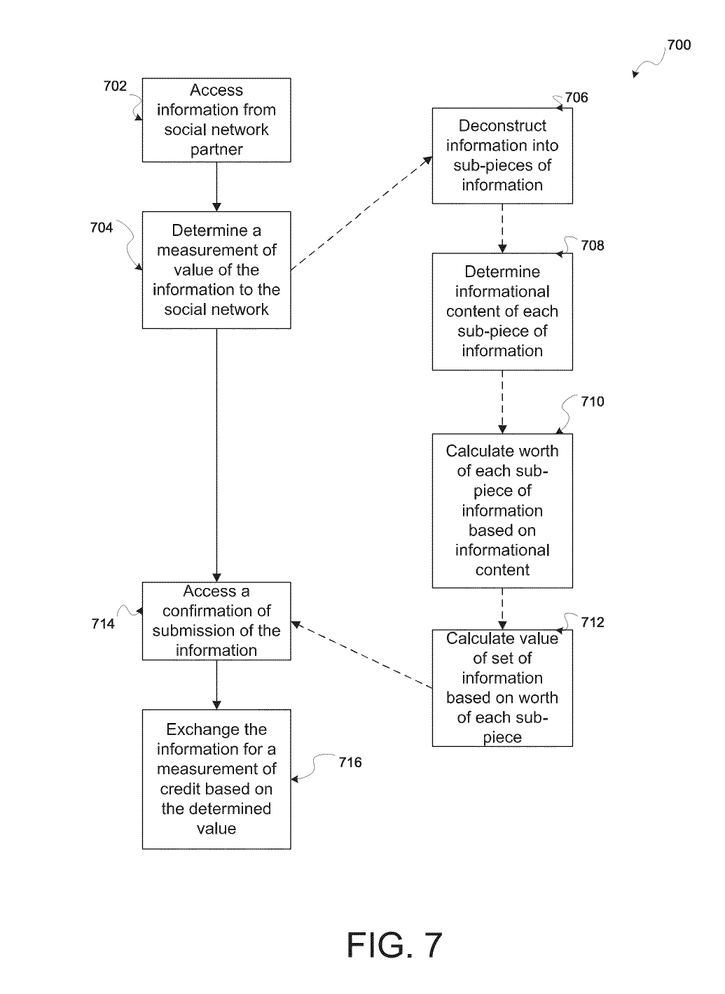

Referring to FIG. 7, the flowchart illustrates an example method 700 for providing information exchange with a social network, according to aspects of the present disclosure. The example method 700 may be consistent with the methods described herein, including, for example, the descriptions in FIGS. 3, 4, 5, and 6; and may be directed from the perspective of a program or device associated with the social network and configured to accept information from a social network partner and provide a valuation of said information to the social network partner. An example of said program or device may be the application server module 204 residing in the social network system 210 or the server machine 110 residing in the network-based system 105.

At block 702, a program or device associated with the social network according to some embodiments may access information from the social network partner. The information provided by the social network partner may be offered by the social network partner to be exchanged for other information provided by the social network. Examples of said information can include the types of information discussed in FIG. 3, as well as other types of information consistent with these disclosures and apparent to those with skill in the art. The information from the social network partner may be submitted by the social network partner, for example, from a user device 130 or 150, by a user 132 or 152 of the social network partner.

At block 704, the program or device associated with the social network may determine a measurement of value of the information to the social network. An example method for determining a measurement of value to the social network may be based on the example description for determining the “worth” and/or “value” described above with respect to FIG. 6. Other examples for making this determination may include referring to tables with prefixed values for different types of information or other processes known to those with skill in the art.

In some example embodiments, more detailed steps for determining a measurement of value of the information may be particularly included in the example method 700. For example, these more detailed steps may be based on the example descriptions for determining a measurement of value of the information as described above with respect to FIG. 6. For example, at block 706, the device or program associated with the social network may deconstruct the information into sub pieces of information. The sub pieces may be determined based on one or more factors, including headers found in the information, keywords found in the information, locations of the information in rows and columns based on how the information is organized, and so on. In some example embodiments, the sub pieces of information may each represent a single unit of information, with each unit intended to be evaluated for individual value.

At block 708, in some example embodiments, the program or device associated with the social network may then determine the informational content of each sub-piece of information. Some example methods for determining the informational content may include performing a text analysis of the information and evaluating the text through natural language processing. In other cases, the text analysis can be based on finding certain key words and categorizing the sub pieces of information based on those keywords. In other cases, the information may be organized in a particular format, and the informational content can be based on where the sub pieces of information are located in the organizational format.

At block 710, in some example embodiments, the program or device associated with the social network may then calculate a measurement of worth of each sub piece of information based on the determined informational content. An example of determining the worth of each sub piece of information may be based on the example methods described above with respect to FIG. 6.

At block 712, in some example embodiments, the program or device associated with the social network may then calculate a measurement of value of the entire set of information based on the calculated worth of each sub piece of information. An example of calculating the value of the entire set of information may be based on the descriptions above with respect to FIG. 6.

At block 714, having determined a measurement of value of the information provided by the social network partner, based either from the general determination discussed in block 704 or the more detailed description in blocks 706 through 712, the program or device associated with the social network may access a confirmation of submission of the information by the social network partner. That is, in some cases, after calculating the measurement of value of the information, this determination may be conveyed to the social network partner or a user of the social network partner. The social network partner or user of the social network partner may then decide whether to submit the information to the social network in exchange for information from the social network or credits used to access information in the social network. An example description of this may be consistent with the descriptions in FIG. 6.

At block 716, the program or device associated with the social network may exchange the information from the social network partner for information from the social network or a measurement of credit to be used for exchanging information, based on the determined value of the information provided by the social network partner. In an example, measurement of credit may be based on the descriptions in FIG. 6. An example of types of information that may be used for exchange for information from the social network may be consistent with the descriptions in FIGS. 4 and 5.

Referring to FIG. 8, the block diagram illustrates components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application, an applet, an app, or other executable code) for causing the machine 800 to perform any one or more of the methodologies discussed herein may be executed, in whole or in part.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include any collection of machines that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a video display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, a signal generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein, including, for example, any of the descriptions of FIGS. 1-7. The instructions 824 may also reside, completely or at least partially, within the main memory 804, within the processor 802 (e.g., within the processor 802's cache memory), or both, before or during execution thereof by the machine 800. The instructions 824 may also reside in the static memory 806.

Accordingly, the main memory 804 and the processor 802 may be considered machine-readable media (e.g., tangible and non-transitory machine-readable media). The instructions 824 may be transmitted or received over a network 826 via the network interface device 820. For example, the network interface device 820 may communicate the instructions 824 using any one or more transfer protocols (e.g., HTTP). The machine 800 may also represent example means for performing any of the functions described herein, including the processes described in FIGS. 1-7.

In some example embodiments, the machine 800 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium is non-transitory in that it does not embody a propagating signal. However, labeling the tangible machine-readable medium as “non-transitory” should not be construed to mean that the medium is incapable of movement; the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, at a device associated with a social network, information from a social network partner, the information being offered as an exchange for information found in the social network;
determining a measurement of value to the social network of the information from the social network partner;
accessing a confirmation to submit the information from the social network partner to the social network, based on the determined measurement of value; and
exchanging the information from the social network partner for a measurement of credit based on the determined measurement of value and the submission confirmation.

2. The method of claim 1, wherein determining the measurement of value to the social network of the information from the social network partner comprises:
deconstructing the information into sub-pieces of information; and
determining informational content of each sub-piece of information.

3. The method of claim 2, wherein determining informational content of each sub-piece of information comprises conducting a text-analysis of each sub-piece of information and associating the sub-piece of information with one or more business categories associated with the social network, based on the text-analysis.

4. The method of claim 2, wherein determining the measurement of value to the social network of the information from the social network partner further comprises:
calculating a measurement of worth of each sub-piece of information based on the informational content.

5. The method of claim 4, wherein calculating the measurement of worth comprises:
comparing each sub-piece of information with information stored in a database of the social network;
determining a measurement of relevancy to the social network for each sub-piece of information;
determining a measurement of uniqueness of each sub-piece of information, based on how likely it is that each sub-piece of information cannot be known through sources other than the social network partner.

6. The method of claim 4, wherein a sub-piece of information among each of the sub-pieces of information has zero worth based on determining that the social network already has access to the sub-piece of information.

7. The method of claim 4, wherein determining the measurement of value to the social network of the information from the social network partner further comprises:
calculating the measurement of value of the information from the social network partner based on the measurements of worth of each sub-piece of information.

8. A system comprising:
a memory configured to store information from a social network partner, the information being offered as an exchange for information found in a social network; and
one or more processors coupled to the memory and configured to:
access the information from the social network partner;
determine a measurement of value to the social network of the information from the social network partner;
access a confirmation to submit the information from the social network partner to the social network, based on the determined measurement of value; and
exchange the information from the social network partner for a measurement of credit based on the determined measurement of value and the submission confirmation.

9. The system of claim 8, wherein determining the measurement of value to the social network of the information from the social network partner comprises:
deconstructing the information into sub-pieces of information; and
determining informational content of each sub-piece of information.

10. The system of claim 9, wherein determining informational content of each sub-piece of information comprises conducting a text-analysis of each sub-piece of information and associating the sub-piece of information with one or more business categories associated with the social network, based on the text-analysis.

11. The system of claim 9, wherein determining the measurement of value to the social network of the information from the social network partner further comprises:
calculating a measurement of worth of each sub-piece of information based on the informational content.

12. The system of claim 11, wherein calculating the measurement of worth comprises:
comparing each sub-piece of information with information stored in a database of the social network;
determining a measurement of relevancy to the social network for each sub-piece of information; and
determining a measurement of uniqueness of each sub-piece of information, based on how likely it is that each sub-piece of information cannot be known through sources other than the social network partner.

13. The system of claim 11, wherein a sub-piece of information among each of the sub-pieces of information has zero worth based on determining that the social network already has access to the sub-piece of information.

14. The system of claim 11, wherein determining the measurement of value to the social network of the information from the social network partner further comprises:
calculating the measurement of value of the information from the social network partner based on the measurements of worth of each sub-piece of information.

15. A computer-readable medium embodying instructions that, when executed by a processor, perform operations comprising:
accessing information from a social network partner, the information being offered as an exchange for information found in the social network;
determining a measurement of value to the social network of the information from the social network partner;
accessing a confirmation to submit the information from the social network partner to the social network, based on the determined measurement of value; and
exchanging the information from the social network partner for a measurement of credit based on the determined measurement of value and the submission confirmation.

16. The computer-readable medium of claim 15, wherein determining the measurement of value to the social network of the information from the social network partner comprises:
deconstructing the information into sub-pieces of information; and
determining informational content of each sub-piece of information.

17. The computer-readable medium of claim 16, wherein determining informational content of each sub-piece of information comprises conducting a text-analysis of each sub-piece of information and associating the sub-piece of information with one or more business categories associated with the social network, based on the text-analysis.

18. The computer-readable medium of claim 16, wherein determining the measurement of value to the social network of the information from the social network partner further comprises:
calculating a measurement of worth of each sub-piece of information based on the informational content.

19. The computer-readable medium of claim 18, wherein calculating the measurement of worth comprises:
comparing each sub-piece of information with information stored in a database of the social network;
determining a measurement of relevancy to the social network for each sub-piece of information;
determining a measurement of uniqueness of each sub-piece of information, based on how likely it is that each sub-piece of information cannot be known through sources other than the social network partner.

20. The computer-readable medium of claim 18, wherein a sub-piece of information among each of the sub-pieces of information has zero worth based on determining that the social network already has access to the sub-piece of information; and
wherein determining the measurement of value to the social network of the information from the social network partner further comprises calculating the measurement of value of the information from the social network partner based on the measurements of worth of each sub-piece of information.
